(19) United States
(12) Patent Application Publication
(10) Pub. No.: US 2014/0361136 A1
(43) Pub. Date: Dec. 11, 2014

(54) ATTACHMENT ASSEMBLY

(71) Applicant: Waxman Consumer Products Group Inc., Bedford Heights, OH (US)

(72) Inventors: Matthew Smith, Wooster, OH (US); Jason A. Sharratt, Wadsworth, OH (US)

(73) Assignee: Waxman Consumer Products Group Inc., Bedford Heights, OH (US)

(21) Appl. No.: 14/294,587

(22) Filed: Jun. 3, 2014

Related U.S. Application Data
(60) Provisional application No. 61/831,613, filed on Jun. 5, 2013.

(51) Int. Cl. F16B 47/00; A47K 10/10

(52) U.S. Cl. CPC F16B 47/006; A47K 10/10
USPC 248/363

(57) ABSTRACT

An attachment assembly is provided that includes a lever arrangement rotatable between a first position and a second position. An adapter is coupled to the lever arrangement for securing the attachment assembly to a surface. The adapter includes a housing that has proximal and distal housing end portions. A suction member is moveably coupled to the lever arrangement. The suction member is actuated from an unattached position to an attached position when the lever arrangement is rotated from the first position to the second position. A draw post is operatively connected to a portion of the lever arrangement and a portion of the suction member. A surface element is connected to a portion of the housing. The surface element forms a sealed connection with the surface when the lever arrangement is moved from the first position to the second position.

### CROSS REFERENCES TO RELATED APPLICATIONS

The following application claims priority to co-pending U.S. Provisional Patent Application Ser. No. 61/831,613 filed Jun. 5, 2013 entitled ATTACHMENT ASSEMBLY. The above-identified application is incorporated herein by reference in its entirety for all purposes.

### TECHNICAL FIELD

The present disclosure relates to an attachment assembly, and more particularly, an attachment assembly that is releasably connected to a surface by actuation of a lever arrangement.

### BACKGROUND

Various suction assemblies have been developed and used to support towels, hangers, and the like. These suctions assemblies are known to attach to hard and smooth surfaces, such as glass or tiled surfaces. Further details of suctions assemblies are further shown and described in U.S. Pat. No. 7,482,245, which is incorporated herein by reference as if reproduced in its entirety.

Suction assembles that are known in the art typically include a suction cup and a support portion for holding a towel, a hanger, and the like. The suction cup is attached to the wall such that a vacuumed seal is formed between the suction cup and the wall. However, when the object is hung on the support portion, the weight of the object may break the vacuumed seal, thereby causing the suction assembly, and thus the object, to fall to the floor.

### SUMMARY

One example embodiment of the present disclosure includes an attachment assembly that includes a lever arrangement rotatable between a first position and a second position. An adapter is coupled to the lever arrangement for securing the attachment assembly to a surface. The adapter includes a housing that has proximal and distal housing end portions. A suction member is moveably coupled to the lever arrangement. The suction member is actuated from an unattached position to an attached position when the lever arrangement is rotated from the first position to the second position. A draw post is operatively connected to a portion of the lever arrangement and a portion of the suction member. A surface element is connected to a portion of the housing. The surface element forms a sealed connection with the surface when the lever arrangement is moved from the first position to the second position.

Another example embodiment of the present disclosure includes an attachment assembly that includes a lever arrangement rotatable between a first position and a second position. The lever arrangement includes a rotatable cam hook. The cam hook includes a support region configured to support an object. A yoke arrangement is spaced from the cam hook. The yoke arrangement includes at least one cam extending therefrom. The at least one cam is configured to engage a portion of the adapter. An adapter is coupled to the lever arrangement for securing the attachment assembly to a surface. The adapter includes a housing. An inner surface is disposed one each of distal and proximal housing end portions. The inner surface includes an annular pocket and a surface element-engaging portion disposed on an distal housing end portion thereof. An outer surface includes a cam element-engaging portion disposed on the proximal housing end portion. An annular rib divides the proximal and distal housing end portions. A suction member is moveably coupled to the draw post to actuate the suction member from an unattached position to an attachment position when the lever arrangement is moved from the first position to the second position. A draw post is operatively connected to the yoke arrangement and a portion of the suction member. A surface element is connected to the surface element-engaging portion. The surface element forms a sealed connection with a desired surface as the lever arrangement is moved from the first position to the second position.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is a left perspective view of an attachment assembly constructed in accordance with one example embodiment of the present disclosure;

FIG. 2 is a right perspective view of FIG. 1;

FIG. 3 is a left side elevation view of FIG. 1;

FIG. 4 is a right side elevation view of FIG. 1;

FIG. 5 is a front perspective exploded view of FIG. 1;

FIG. 6 is a rear perspective exploded view of FIG. 1;

FIG. 7 is a front elevation view of FIG. 1;

FIG. 8 is a sectional view of an attachment assembly along section lines 8-8 in FIG. 7 in an unattached first position; and

FIG. 9 is a sectional view of an attachment assembly along section lines 9-9 in FIG. 7 in an attached second position.

### DETAILED DESCRIPTION

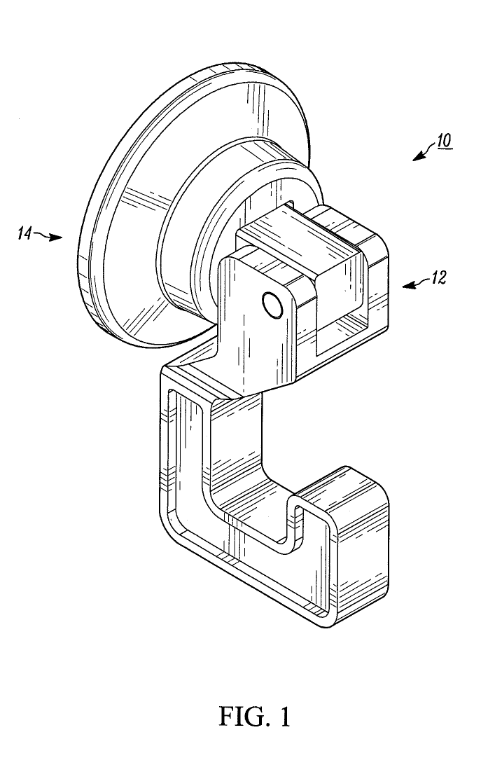

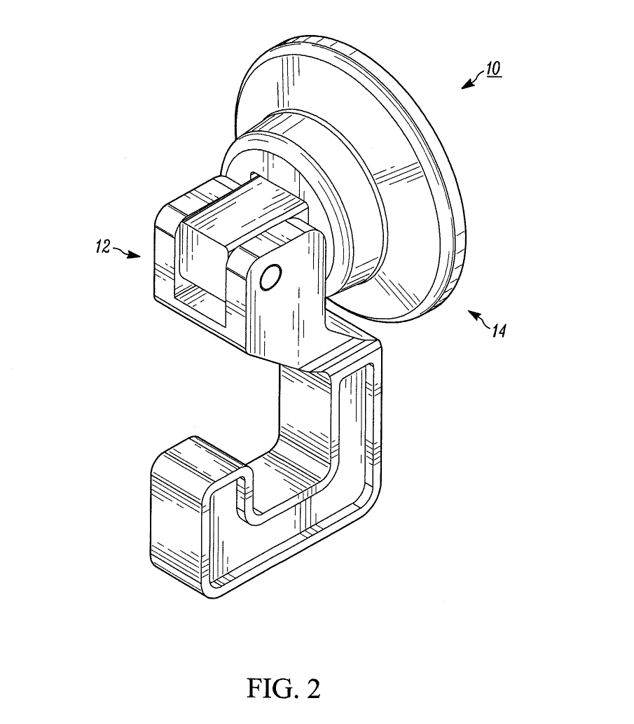

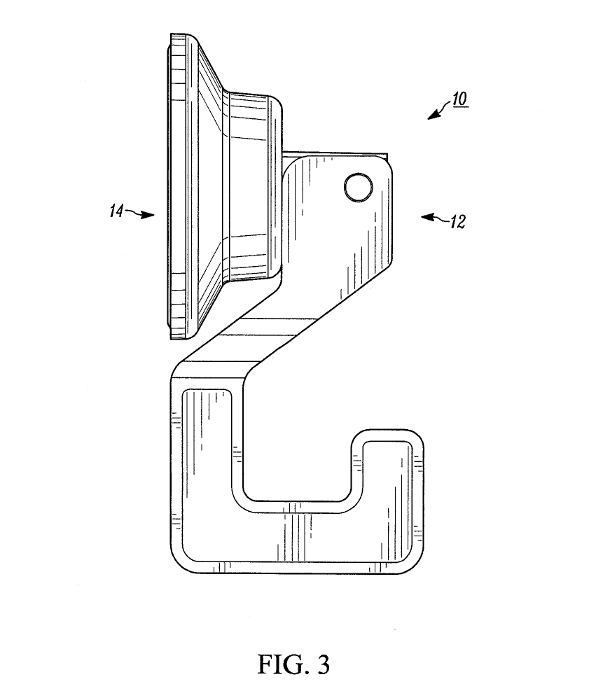

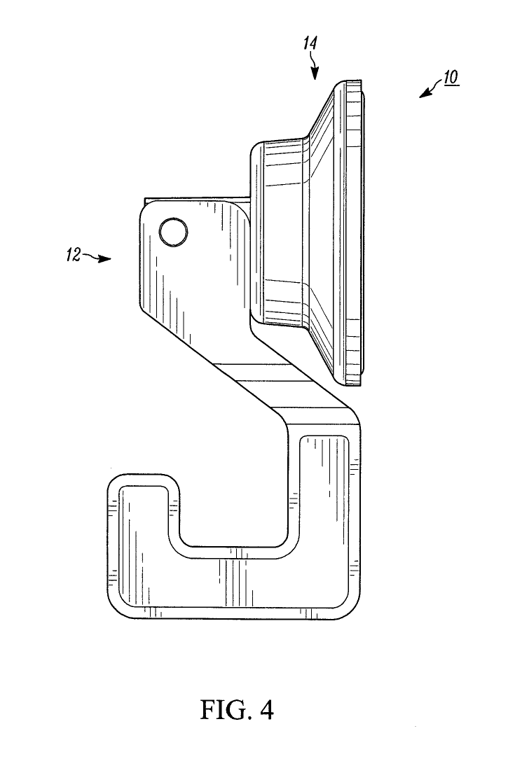

Referring now to the figures generally, the present disclosure relates to an attachment assembly 10, and more particularly, an attachment assembly 10 that is releasably connected to a surface by rotatable actuation of a lever arrangement 12. FIGS. 1 and 2 are left and right perspective views of an attachment assembly 10 constructed in accordance with one example embodiment of the present disclosure. FIGS. 3 and 4 are left and right side elevation views of the attachment assembly 10. As shown in FIGS. 1-4, the lever arrangement 12 of the attachment assembly 10 is coupled to an adapter 14.

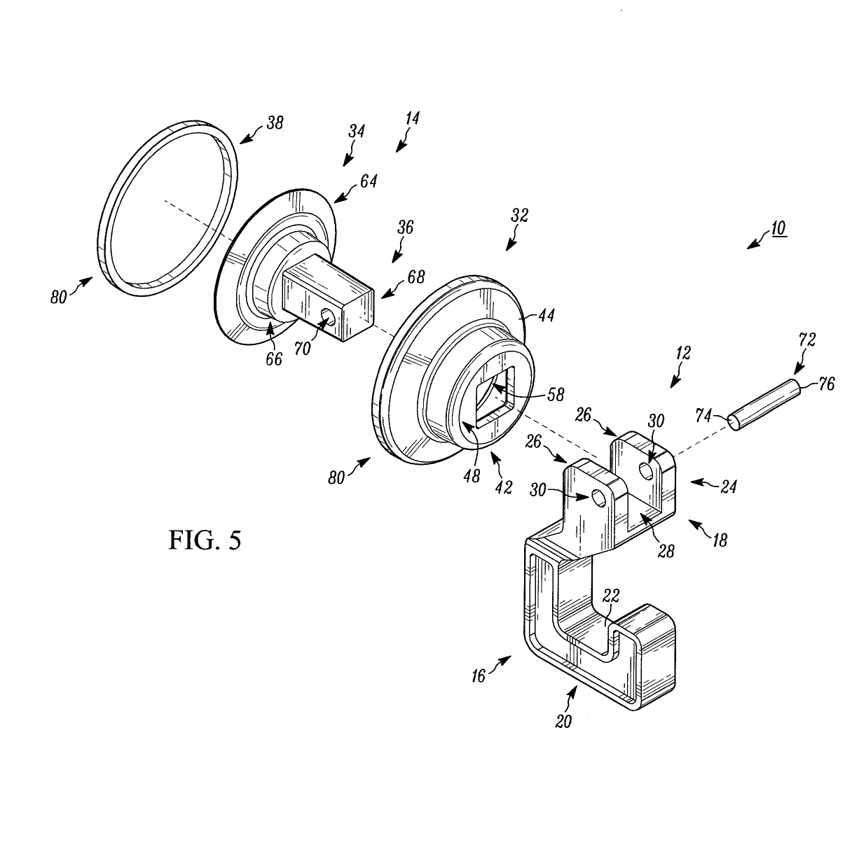

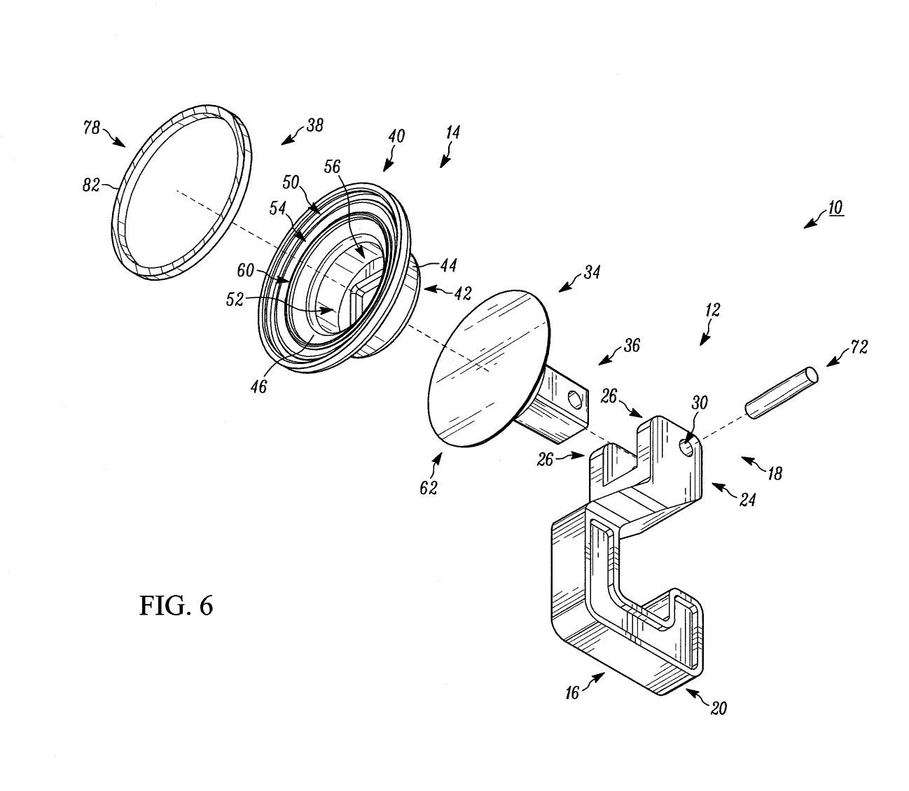

As shown in FIGS. 5 and 6, the lever arrangement 12 includes a distal lever end portion 16 and a proximal lever end portion 18. The lever arrangement 12 may be made from plastic. However, other materials of equal strength may also be used without departing from the spirit and scope of the claimed disclosure. The distal lever end portion 16 includes a cam hook 20 is configured to hold and support an object (not shown) (e.g., a towel, a hanger, etc.). The cam hook 20 has a generally C-shaped configuration; however, the cam hook 20 may have any suitable shape configuration. In one example embodiment, the cam hook 20 includes a support region 22 configured to support the object.

The proximal lever end portion 18 includes a yoke arrangement 24. The yoke arrangement 24 is configured to guide rotational movement of the cam hook 20 relative to the adapter 14. The yoke arrangement 24 has a substantially U-shaped configuration; however the yoke arrangement 24 may have any suitable configuration. In one example embodiment, the yoke arrangement 24 may include a pair of cams 26 disposed on opposing sides thereof. The cams 26 are each configured to engage a portion of the adapter 14, as described in more detail below. The cams 26 protrude away from the proximal lever end portion 18, thereby defining a draw post-receiving slot 28 disposed between each of the cams 26. Each cam 26 includes a pivot pin opening 30 extending through the corresponding cam 26.

FIGS. 5 and 6 also shows that the adapter 14 comprises a housing 32, a suction member 34, a draw post 36, and a surface element 38. The housing 32 is configured to support each of the suction member 34, the draw post 36, and the surface element 38. The housing 32 has a generally circular shape; however, the housing 32 may have any suitable shape (e.g., rectangular). The housing 32 may be made from plastic; however, other materials of equal strength could also be used without departing from the spirit and scope of the claimed disclosure. The housing 32 includes a distal housing end portion 40 and a proximal housing end portion 42. In one example embodiment, the distal housing end portion 40 and the proximal housing end portion 42 may be integrally molded together. In another example embodiment, the distal housing end portion 40 and the proximal housing end portion 42 may be removably attached together. The distal housing end portion 40 has a diameter D1 that is greater than a diameter D2 of the proximal housing end portion 42. It will be appreciated that this change in diameter on the housing 32 defines the distal housing end portion 40 and the proximal housing end portion 42.

The housing 32 also includes an outer housing surface 44 and an inner housing surface 46. The outer and inner housing surfaces 44 and 46 are disposed on each of the distal and proximal housing end portions 40 and 42. The proximal housing end portion 42 includes a cam-engaging portion 48 disposed on a portion of the outer housing surface 44. The cam-engaging portion 48 is configured to engage at least a portion of the cams 26. The distal housing end portion 40 includes a surface element-engaging portion 50 disposed on a portion of the inner housing surface 46. The surface element-engaging portion 50 is configured to engage at least a portion of the surface element 38.

The inner housing surface 46 also defines an annular pocket 52. The annular pocket 52 includes a distal annular pocket end portion 54 and a proximal annular pocket end portion 56 disposed within each of the respective distal and proximal housing end portions 40 and 42. The annular pocket 52 is configured to receive at least a portion of the suction member 34, as described in more detail below.

A draw post channel 58 extends from the outer housing surface 44 disposed on the proximal housing end portion 42 and abuts the proximal annular pocket end portion 56. The draw post channel 58 is sized and dimensioned to receive a portion of the draw post 36, as described in more detail below. As shown in FIGS. 5 and 6, the draw post channel 58 is rectangular; however, it will be appreciated that the draw post channel 58 has a shape that corresponds to the shape of the draw post 36.

An annular rib 60 is disposed on a portion of the inner housing surface 46. The annular rib 60 substantially extends across the diameter D1 of the distal housing end portion 40 on the inner housing surface 46. The annular rib 60 is configured to apply a force to at least a portion of the suction member 34 during rotational actuation of the lever arrangement 12, as described in more detail below.

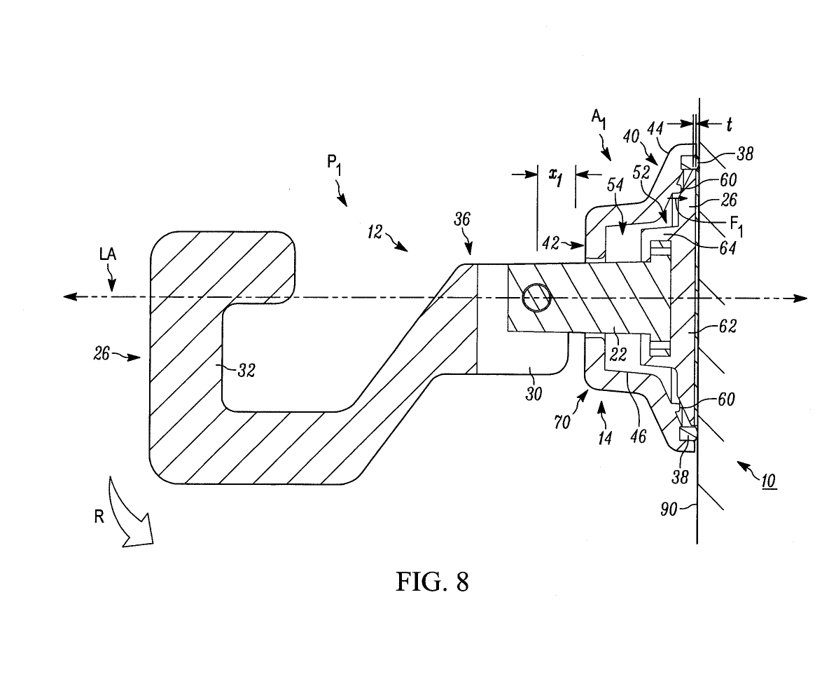

The suction member 34 is configured to connect the attachment assembly 10 to an external surface (not shown in FIGS. 5 and 6). The suction member 34 is sized and dimensioned for receipt within the annular pocket 52. In one example embodiment, the suction member 34 may be approximately one inch (1″) in diameter, but should be appreciated that the suction member 34 could be larger or smaller in size as desired. In another example embodiment, the suction member 34 is approximately one-eighth of one inch (⅛″) thick as indicated by dimension “t” in FIG. 8, covering substantially 99% of the surface area of the suction member 34.

The suction member 34 may be made from polyvinyl chloride (PVC); however, other materials of equal strength could also be used without departing from the spirit and scope of the claimed disclosure. In one example embodiment, the suction member 34 is made from PVC material having a durometer of approximately 85 on a shore A scale. The suction member 34 has a generally circular shape; however, the suction member 34 may have any suitable shape (e.g., rectangular). In another example embodiment, the suction member 34 may be configured as a suction cup; however, the suction member 34 may have any suitable configuration.

As shown in FIGS. 5 and 6, the suction member 34 includes a distal suction member end portion 62 and a proximal suction member end portion 64. The distal suction member end portion 62 is configured to attach the attachment assembly 10 to an external surface. The proximal suction member end portion 64 is configured to engage a portion of the draw post 36, as described in more detail below.

The draw post 36 is configured to connect the suction member 34 to the yoke arrangement 24. The draw post 36 has a generally rectangular shape; however, the draw post 36 may have any suitable shape. It will be appreciated that the draw post 36 has a shape that corresponds to the shape of the draw post channel 58. The draw post 36 may be made from plastic. However, other materials of equal strength may also be used without departing from the spirit and scope of the claimed disclosure.

In one example embodiment, the draw post 36 may include a distal draw post end portion 66 and a proximal draw post end portion 68. The distal draw post end portion 66 is integrally molded to a portion of the proximal suction member end portion 64. However, it may be appreciated that the distal draw post end portion 66 may be removably attached to the proximal suction member end portion 64. The proximal draw post end portion 68 is configured for receipt by the draw post-receiving slot 28 of the yoke arrangement 24. The proximal draw post end portion 68 includes a pivot pin channel 70 that extends laterally therethrough. The pivot pin channel 70 is configured for alignment with the pivot pin openings 30 of the cams 26. It will be appreciated that the pivot pin channel 70 has the same cross-sectional shape as the pivot pin openings 30.

A pivot pin 72 is configured to connect the proximal draw post end portion 68 to the cams 26. The pivot pin 72 is made from plastic. However, other materials of equal strength may also be used without departing from the spirit and scope of the claimed disclosure. The pivot pin 72 has a generally cylindrical shape; however, the pivot pin 72 may have any suitable shape corresponding to the cross-sectional shape of each of the pivot pin openings 30 and the pivot pin channel 70. The pivot pin 72 is sized and dimensioned to snugly fit within the pivot pin openings 30 and the pivot pin channel 70, as described in more detail below. In one example embodiment, the pivot pin 72 includes a first pivot pin end 74 and a second pivot pin end 76.

The surface element 38 is configured to enhance a connection between the attachment assembly 10 and a surface. The surface element 38 has a generally circular shape; however, the surface element 38 may have any suitable shape (e.g., rectangular). The surface element 38 may be made from polyurethane; however, other materials of equal strength could also be used without departing from the spirit and scope of the claimed disclosure. In one example embodiment, the surface element 38 is made from polyurethane having a durometer of approximately between 70-80 on a shore A scale.

The surface element 38 advantageously allows the attachment assembly 10 to be securely connected to surfaces having imperfections that would not allow attachment by conventional suction assemblies. That is, the surface element 38 allows the attachment assembly 10 to attach to rough surfaces by filling in gaps and imperfections on the rough surface, thereby preventing the attachment assembly 10 from disengagement with the rough surface.

As shown in FIG. 6, the surface element 38 is sized and dimensioned for attachment with the surface element-engaging portion 50. The surface element 38 is disposed within a portion of the distal annular pocket end portion 54. In one example embodiment, the surface element 38 may have a diameter equal to the diameter D1 of the distal housing end portion 40, but should be appreciated that the suction member 34 could be larger or smaller in size as desired. In another example embodiment, the surface element 38 may be configured as a ring-shaped member extending circumferentially about the distal housing end portion 40; however the surface element 38 may have any suitable configuration.

The surface element 38 includes a distal surface element end portion 78 and a proximal surface element end portion 80. The distal surface element end portion 78 is configured to interact with an external surface (not shown in FIGS. 5 and 6), as described in more detail below. The distal surface element end portion 78 includes a sticky portion 82 disposed on at least a portion thereof. Advantageously, the sticky portion 82 extends circumferentially about the distal surface element end portion 78. The sticky portion 82 allows the surface element 38 to be securely attached to the external surface. In one example embodiment, the sticky portion 82 may advantageously fill in gaps or other imperfections on the external surface. The proximal surface element end portion 80 is sized and dimensioned for attachment to the surface element-engaging portion 50 with adhesives (or any other suitable attachment mechanism).

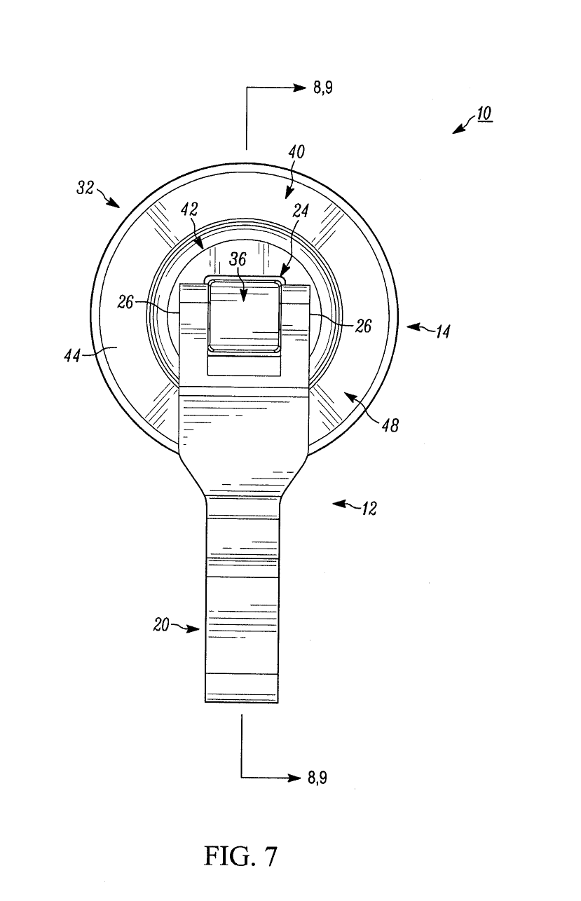

As shown in FIG. 7, to assemble the attachment assembly 10, the adapter 14 is connected to the lever arrangement 12. The proximal draw post end portion 68 is positioned within a portion of the annular pocket 52 and advanced through the draw post channel 58 until the proximal suction member end portion 64 contacts the annular rib 60. The annular rib 60 applies a compression force F₁ to the proximal suction member end portion 64 to prevent further movement of the suction member 34 towards the proximal housing end portion 42.

After advancement through the draw post channel 58, the proximal draw post end portion 68 is positioned within the draw post-receiving slot 28 such that the pivot pin openings 30 are substantially aligned with the pivot pin channel 70. The pivot pin 72 is then inserted into one of the pivot pin openings 30, through the pivot pin channel 70, and into the other of the pivot pin openings 30. It will be appreciated that, once installed, the first pivot pin end 74 and the second pivot pin end 76 are each substantially flush with the proximal lever end portion 18.

To complete the assembly of the attachment assembly 10, the proximal surface element end portion 80 is attached to the surface element-engaging portion 50. In one example embodiment, the proximal surface element end portion 80 may be connected to the surface element-engaging portion 50 with adhesives. It will be appreciated that any of the above-described assembly steps may be performed in any suitable order such as, for example, the surface element 38 may be attached to the surface element-engaging portion 50 prior to the coupling of the draw post 36 with the yoke arrangement 24.

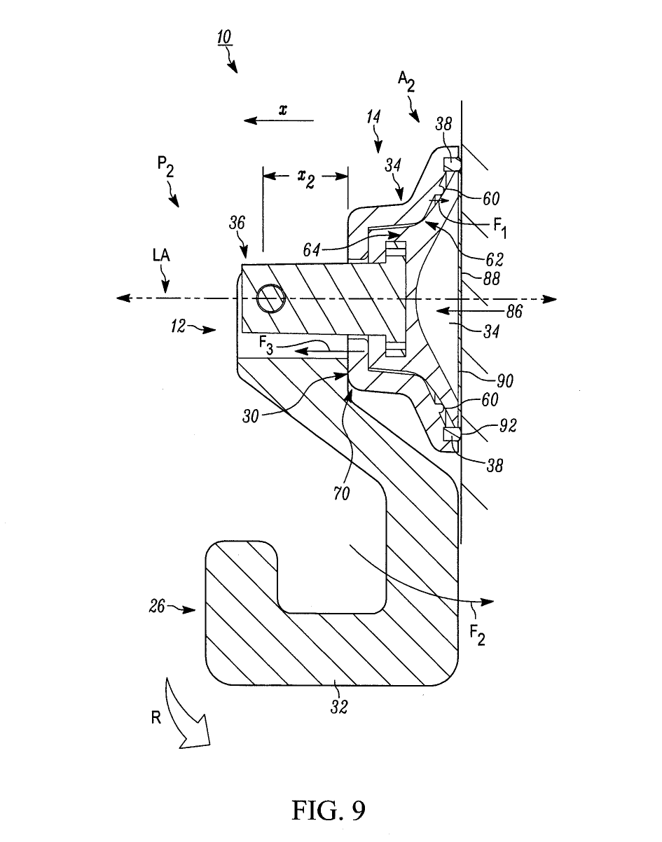

FIGS. 8 and 9 show that the attachment assembly 10 may be selective removably attachable to a surface 84, such as a wall, glass, mirror, dry wall, papered surface, plaster, and the like. The attachment assembly 10 is positioned on the surface 84 so that the lever arrangement 12 is in a first position P₁ and the adapter 14 is in an unattached position A₁. As illustrated in FIG. 8, the lever arrangement 12 is in the first position P₁ such that the cam hook 20 is substantially coaxial with a longitudinal axis LA of the attachment assembly 10. The cams 26 are spaced from the cam-engaging portion 48.

In the unattached position A₁, the distal surface element end portion 78 and the distal suction member end portion 62 each contact, and are substantially planar with, the surface 84. The proximal draw post end portion 68 is spaced from the proximal housing end portion 42 at a first distance X₁. The suction member 34 is positioned within the distal annular pocket end portion 54 so that the distal suction member end portion 62 is disposed distally relative to the annular rib 60, and the proximal suction member end portion 64 is disposed proximally relative to the annular rib 60. The annular rib 60 applies a compression force F₁ to the distal suction member end portion 62 to maintain the position of the suction member 34 within the annular pocket 52. The annular pocket 52 has a pressure differential PD₁ that is greater than or equal to the pressure differential of air.

To attach the attachment assembly 10 to the surface 84, the lever arrangement 12 is actuated in a radial direction R from the first position P₁ to a second position P₂, as shown in FIG. 9. A rotational force F₂ is applied to a portion of the cam hook 20 to rotate the lever arrangement 12 from the first position P₁ to the second position P₂. During rotation of the lever arrangement 12, the cams 26 move radially in the radial direction R about the pivot pin 72 until the cams 26 contact the cam-engaging portion 48. The cam-engaging portion 48 provides a reaction surface that acts upon the cams 26. In one example embodiment, the cams 26 may engage the cam-engaging portion 48 prior to the lever arrangement 12 reaching the second position P₂ shown in FIG. 9. Upon further rotation of the lever arrangement 12, the cam-engaging portion 48 applies a reaction force F₃ to the cams 26.

The reaction force F₃ applied to the cams 26 is greater than the rotational force F₂ applied to the cam hook 20, but less than the compression force F₁ applied by the annular rib 60 to the distal suction member end portion 62. As this is the case, the reaction force F₃ allows the lateral movement of the draw post 36 in a direction X, which causes the proximal suction member end portion 64 to move laterally with the draw post 36 in the direction X. The compression force F₁ maintains the position of the distal suction member end portion 62 within the annular pocket 52. Thus, the distal suction member end portion 62 maintains its position and the proximal suction member end portion 64 is moves laterally with the draw post 36 during rotation of the lever arrangement 12.

As shown in FIG. 9, the lever arrangement 12 reaches the second position P₂ when the cam hook 20 is substantially perpendicular to the longitudinal axis LA. When the lever arrangement 12 is in the second position P₂, the adapter 14 is in a corresponding attached position A₂. In the attached position A₂, the draw post 36 is spaced from the proximal housing end portion 42 at a second distance X₂. The suction member 34 pivots about the annular rib 60 so that the proximal suction member end portion 64 moves laterally with the draw post 36 while the distal suction member end portion 62 is compressed towards the surface 84. Thus, the suction member 34 is “stretched” to form a cavity 86 therewithin that fills substantially the annular pocket 52. The annular rib 60 applies an additional compression force F₄ to prevent the proximal suction member end portion 64 from distally advancing past the annular rib 60 towards the surface 84.

A vacuum (or negative sealed pressure, which is less than atmospheric pressure) is formed within the cavity 86 between the suction member 34 and the surface 84 in the direction of arrow X. The cavity 86 has a pressure differential PD₂ that is less than the pressure differential PD₁ when the suction member 34 is in the unattached position A₁. In one example embodiment, the pressure differential PD₂ is less than the pressure differential of air or atmospheric pressure, thereby forming the vacuum within the cavity 86. The pressure differential PD₂ is created when the cavity 86 is formed during the lateral movement of the draw post 36 as the lever arrangement 12 is actuated from the first position P1 to the second position P2.

Once the pressure differential PD₂ is created within the cavity 86, a sealed connection 88 is created between the surface 84 and the adapter 14. It will be appreciated that the cross-sectional shape of the sealed connection 88 corresponds to the cross-sectional shape of the surface element 38 (e.g., circular, rectangular, etc.). The sealed connection 88 extends circumferentially about the perimeter of the distal surface element end portion 78. Advantageously, the sticky portion 82 of the distal surface element end portion 78 forms a substantially tacky connection with the surface 84, thereby maintaining the pressure differential PD₂ within the cavity 86.

The sealed connection 88 advantageously enhances the holding power of the attachment assembly 10 to the surface 84. That is, the second pressure differential PD₂ of the cavity 86 of the suction member 34 creates an initial seal 90 between the adapter 14 and the surface 84. The engagement of the sticky portion 82 of the surface element 38 provides a secondary seal 92 between the adapter 14 and the surface 84. Since the suction member 34 and the surface element 38 are made from materials with different durometers and have and constructions, the suction member 34 and the surface element 38 are subjected to different stress rates and deformation rates when an object (e.g., a towel, a hanger, etc.) is hung on the support region 22 of the cam hook 20 over an extended period of time. That is, if one of the initial and secondary seals 90 and 92 fails, the other of the initial and secondary seals 90 and 92 maintains the sealed connection 88 between the adapter 14 and the surface 84.

In one example embodiment, a protective cover (not shown), such as a label, film or saran wrap like sheath is used to surround and protect sticky portion 82 of the surface element 38 from debris prior to use. The protective cover may be removed just prior to attachment of the attachment assembly 10 to the surface 84.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. An attachment assembly comprising:
a lever arrangement rotatable between a first position and a second position; and
an adapter coupled to the lever arrangement for securing the attachment assembly to a surface, the adapter comprising:
a housing having proximal and distal housing end portions;
a suction member moveably coupled to the lever arrangement, the suction member being actuated from an unattached position to an attached position when the lever arrangement is rotated from the first position to the second position;
a draw post operatively connected to a portion of the lever arrangement and a portion of the suction member; and
a surface element connected to a portion of the housing, the surface element forming a sealed connection with the surface when the lever arrangement is moved from the first position to the second position.

2. The attachment assembly of claim 1, wherein the lever arrangement comprises:
a cam hook rotatable relative to the adapter, the cam hook including a support region configured to support an object; and
a yoke arrangement spaced from the cam hook, the yoke arrangement being operatively connected to a portion of the draw post.

3. The attachment assembly of claim 2, wherein the cam hook is substantially parallel to a longitudinal axis of the attachment assembly when the lever arrangement is in the first position, and substantially perpendicular to the longitudinal axis when the lever arrangement is in the second position.

4. The attachment assembly of claim 2, wherein the draw post laterally moves when the lever arrangement is rotated from the first position to the second position, the lateral movement of the draw post actuating the suction member from the unattached position to the attached position.

5. The attachment assembly of claim 4, wherein the housing includes:
an outer surface including a cam element-engaging portion disposed on the proximal housing end portion;
and
an inner surface disposed within each of the distal and proximal housing end portions, the inner surface including:
an annular pocket configured to receive at least a portion of each of the suction member and the surface element; and
a surface element-engaging portion disposed within the distal housing end portion.

6. The attachment assembly of claim 5, wherein the yoke arrangement includes at least one cam extending therefrom; and
wherein, upon rotation of the lever arrangement from the first position to the second position, the cam-engaging portion contacts, and applies a force to, the at least one cam, thereby causing lateral movement of the draw post and the suction member.

7. The attachment assembly of claim 5, wherein the housing further includes an annular rib dividing the proximal and distal housing end portions, the annular rib applying a first force to a portion of the suction member when the lever arrangement is in the first position, thereby preventing the suction member from movement, and applying a second force to the portion of the suction member when the lever arrangement is in the second position, thereby compressing the portion of the suction member towards the surface.

8. The attachment assembly of claim 8, wherein, upon movement of the suction member from the unattached position to the attachment position, a cavity is formed within the suction member, the cavity having a pressure level lower than the pressure level of the suction member when the suction member is in the unattached position.

9. The attachment assembly of claim 8, wherein the surface element is spaced from the suction member when the cavity is formed.

10. The attachment assembly of claim 1, wherein the suction member is formed from a first durometer material and the surface element being formed from a second durometer material different from the first durometer material.

11. The attachment assembly of claim 1, wherein the surface element includes a sticky layer disposed on at least a portion thereof.

12. The attachment assembly of claim 1, wherein the surface element extends circumferentially about a perimeter of the housing.

13. The attachment assembly of claim 1, wherein a sealed connection is formed between the adapter and the surface, the sealed connection having:
an initial seal between the suction member and the surface; and
a secondary seal between the surface element and the surface.

14. An attachment assembly comprising:
a lever arrangement rotatable between a first position and a second position, the lever arrangement comprising:
a rotatable cam hook, the cam hook including a support region configured to support an object; and
a yoke arrangement spaced from the cam hook, the yoke arrangement including at least one cam extending therefrom, the at least one cam being configured to engage a portion of the adapter;
and
an adapter coupled to the lever arrangement for securing the attachment assembly to a surface, the adapter comprising:
a housing, including:
an inner surface disposed one each of distal and proximal housing end portions, the inner surface including an annular pocket and a surface element-engaging portion disposed on an distal housing end portion thereof; and
an outer surface including a cam element-engaging portion disposed on the proximal housing end portion;
an annular rib dividing the proximal and distal housing end portions;
a suction member moveably coupled to the draw post to actuate the suction member from an unattached position to an attachment position when the lever arrangement is moved from the first position to the second position;
a draw post operatively connected to the yoke arrangement and a portion of the suction member; and
a surface element connected to the surface element-engaging portion, the surface element forming a sealed connection with the surface as the lever arrangement is moved from the first position to the second position.

15. The attachment assembly of claim 15, wherein, upon rotation of the lever arrangement from the first position to the second position, the cam-engaging portion contacts, and applies a force to, the at least one cam, thereby causing lateral movement of the draw post and the suction member.

16. The attachment assembly of claim 15, wherein the annular rib applies a first force to a portion of the suction member when the lever arrangement is in the first position, thereby preventing the suction member from movement, and applies a second force to the portion of the suction member when the lever arrangement is in the second position, to compress the portion of the suction member towards the surface, thereby forming a cavity within the suction member, the cavity having a pressure level lower than the pressure level of the suction member when the suction member is in the unattached position.

17. The attachment assembly of claim 15, wherein the suction member is formed from a first durometer material and the surface element being formed from a second durometer material different from the first durometer material.

18. The attachment assembly of claim 15, wherein the surface element includes a sticky layer disposed on at least a portion thereof.

19. The attachment assembly of claim 15, wherein the surface element extends circumferentially about the perimeter of the housing,

20. The attachment assembly of claim 15, wherein a sealed connection is formed between the adapter and the surface, the sealed Connection having:
an initial seal between the suction member and the surface; and
a secondary seal between the surface element and the surface.
